(19) United States
(12) Patent Application Publication
(10) Pub. No.: US 2009/0269157 A1
(43) Pub. Date: Oct. 29, 2009

(54) ANCHOR

(76) Inventors: Hannes Spieth, Filderstadt (DE); Peter Schillinger, Ebhausen (DE); Jan Hofmann, Dornstetten (DE)

Correspondence Address: MICHAEL J. STRIKER, 103 EAST NECK ROAD, HUNTINGTON, NY, 11743, US

(21) Appl. No.: 12/439,949

(22) PCT Filed: Sep. 11, 2007
(86) PCT No.: PCT/EP2007/007888

§ 371 Date: Mar. 4, 2009

(30) Foreign Application Priority Data
Oct. 14, 2006 (DE) 10 2006 048 655.2

(51) Int. Cl. F16B 31/02

(52) U.S. Cl. 411/10

(57) ABSTRACT

The invention relates to anchors for fixing an article (2) to a substrate (3). In order to improve such an anchor (4) in respect of its capacity to absorb transverse force in the event of earthquakes, the invention proposes that the anchor (4) have a conversion device (14) such that movement of an article (2) fixed with the anchor (4) relative to the substrate (3) and transverse to the longitudinal axis of the anchor (4) results predominantly in an increase in the axially acting pre-tensioning force of the anchor (4).

The invention relates to an anchor for fixing an article to a substrate, having the features of the preamble of claim 1.

A wide variety of anchors, also referred to as fixing plugs, are known for fixing articles to a substrate. They can be divided into those which anchor by expanding, those which are anchored in an undercut drilled hole and those which are anchored in the substrate by means of a hardenable composition. It is also known to configure such fixing plugs so that they are capable of further expansion in the event of a crack's passing through the drilled hole. Such anchors are especially suitable for fixing in the tension zone of a substrate, for example on the underside of a concrete ceiling. It is increasingly being demanded that anchors be improved so that they do not fail even under the severe loads caused by earthquakes, where failure is predominantly a result of transverse stress, that is to say movement of the article relative to the substrate and transverse with respect to the longitudinal axis of the anchor, i.e. usually parallel to the surface of the substrate. In the undisturbed state, such transverse loading on the fixing plug is largely avoided because the fixing plug is pre-tensioned axially against the substrate and thus presses the article against the surface of the substrate, the surface-normal forces that arise creating surface-parallel frictional forces which are able to counteract potential transverse forces on the article. It is known, for example, from the publication DE 101 34 809 A1 to clamp a frictional-force-enhancing element between an article and a substrate in order to improve the capacity to absorb transverse forces in that region. In the event of severe shock-like loads, such as occur during earthquakes, and simultaneous widening of the drilled hole caused by cracks in the substrate, an anchor such as that described in the mentioned publication can nevertheless be displaced axially. That is generally anyway necessary for further expansion of an anchor. In the absence of further measures, however, that has the result that the pre-tensioning force of the anchor is diminished, with the consequence that the frictional forces between the article and the substrate are reduced and movement of the article relative to the substrate takes place. That leads to transverse loading on the anchor which is a critical factor in failure of the anchor. In order to counteract that effect, spring elements can be provided between the anchor and the article. The publication DE 33 31 097 A1 may be mentioned here by way of example. Although those spring elements to some extent retain the pre-tensioning forces, failure in the event of shock-like loads can be combated only inadequately. For example, the axial forces acting through the spring element in the undisturbed state have to be limited on account of the axial load-bearing capacity of the anchor, since otherwise there is a risk that failure will be caused by axial forces instead of by transverse forces.

The problem underlying the invention is therefore to provide anchors which, while having comparable dimensions, are able to absorb higher loads, especially in the event of earthquakes.

According to the invention, that problem is solved by an anchor having the features of claim 1. The invention is based on the assumption that transverse movement of the article relative to the substrate is ultimately unavoidable. It is therefore proposed that the anchor have a conversion device which converts the transverse movement into an increased pre-tensioning force, that is to say an axial force on the anchor. That is to say, should such a transverse movement occur, the pre-tensioning force is increased as a result of the conversion device alone, without it being absolutely necessary, in addition, to have a spring element for that purpose. The increase in the pre-tensioning force gives rise to an increase in the normal force between the article and the substrate and accordingly in the frictional forces which, in turn, counteract displacement between the article and the substrate. A kind of braking action therefore develops which, ideally, is such that as displacement of the article increases, the pre-tension increases proportionally or superproportionally. It will be understood that there must be a certain amount of radial play between the anchor and the article, so that just a slight displacement does not result in radial contact between the anchor and the substrate such that direct transmission of transverse force takes place at that location even before the movement has ceased.

Since not every transverse force on the anchor will result in failure of the anchor, the anchor preferably has a transverse force element which fails precisely when a critical transverse force is reached, that is to say the transverse force element allows movement of the article relative to the substrate before the anchor fails as a result of transverse forces. For that purpose, the transverse force element has, for example, a desired rupture location.

Preferably, the anchor has, in addition, a restoring element which has the effect, in an ideal case, of returning the article to its original position after it has been displaced therefrom. The restoring element therefore gives rise to a restoring force on the article which counteracts the first movement of the article.

As conversion device the invention proposes the provision of a sliding-contact bearing between a mounting zone of the anchor and the article. The mounting zone of the anchor is to be understood as that portion which protrudes from the drilled hole in the substrate and herein especially a nut screwed onto the shank of the anchor, or a screw head integral with the anchor. The sliding-contact bearing is directed towards facilitating movement between the mounting zone and the article. Accordingly, the term “sliding-contact bearing” is not to be interpreted narrowly, but in the sense of a wanted mobility. For example, roller bearings are also included. Preferably, the sliding-contact bearing has spherical sliding faces, the sliding faces being concave seen in the direction of the substrate. Spherical sliding faces have the advantage of simple geometry which, on every movement of the article in the direction of the surface of the substrate, bring about a conversion of that movement into an axial movement. In order to obtain the best possible sliding characteristics, the slidinq faces can be polished and/or coated. A lubricant can also be provided between the sliding faces.

In order that the pre-tension of the anchor can be retained as satisfactorily as possible in the event of shock-like loading, a preferred embodiment of the anchor has, in addition to the conversion device, a spring element between the mounting zone of the anchor and the sliding-contact bearing. That combination, when appropriately matched, offers a particularly good way of optimising the behaviour in the event of a wide range of transverse and axial forces. The spring element is preferably arranged between the mounting zone of the anchor and the sliding-contact bearing.

As an alternative to or preferably in addition to the spring element, a damping element can be provided which damps the transverse movement of the article relative to the anchor. It can be arranged, for example, between the spherical bearing shells and the shank of the anchor or parallel to the described spring element. “Parallel” is to be understood as meaning that it acts in the same direction as the spring element; it is therefore possible to provide, for example, a combined spring/damper element. A combination of damping elements at a plurality of locations is also possible.

The conversion device preferably takes the form of a unit insertable into a recess in the article to be mounted. The manufacturer of the article therefore needs only to provide, for example, a though-bore of a given diameter.

The invention is described below with reference to an exemplary embodiment.

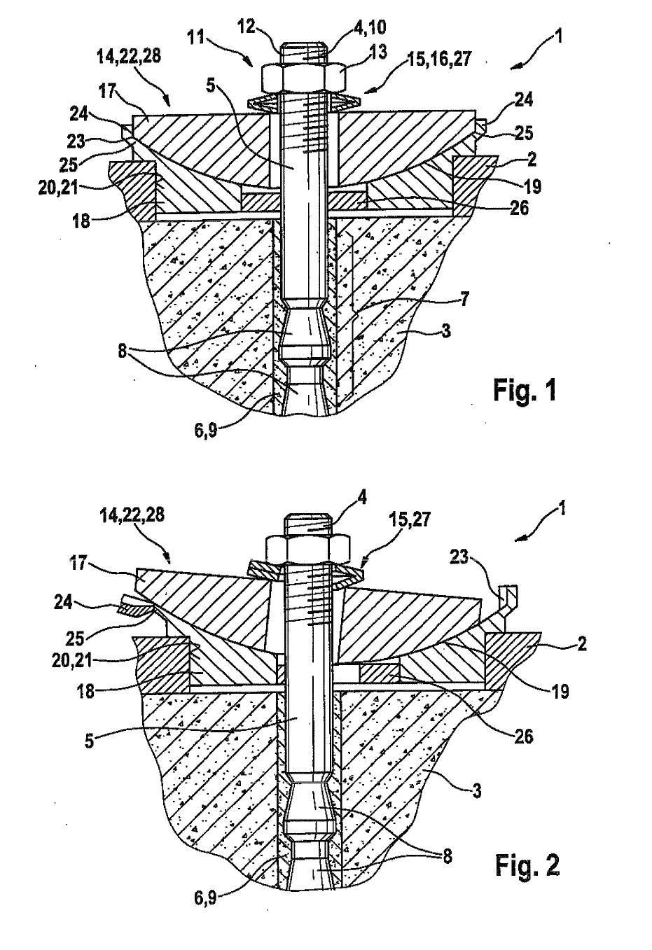

FIG. 1 is a sectional view of the exemplary embodiment in the mounted state; and

FIG. 2 is a sectional view of the same exemplary embodiment after displacement of the mounted article.

The fixing arrangement 1 shown in FIG. 1 is used for fixing an article 2 to a substrate 3. The fixing arrangement 1 has for that purpose an anchor 4 having an elongate shank 5 which has been inserted in a drilled hole 6 in the substrate 3. The portion of the shank 5 inserted in the drilled hole 6 forms an anchoring zone 7. In this exemplary embodiment, that anchoring zone 7 is formed especially by a plurality of cones 8 that widen in the direction of introduction of the anchor 4. The anchoring zone 7 is surrounded by a hardenable composition 9; it is accordingly a chemical anchoring. The cones 8 allow further expansion of the anchor 4 in the event of the drilled hole's becoming wider. Instead of a chemical anchoring it would be equally possible to use a mechanical anchoring, that is to say, for example, an anchor having an expanding action or an undercut anchor. At the end 10 of the anchor 4 opposite from the anchoring zone 7, the anchor has a mounting zone 11. It is formed by an external thread 12 and a nut 13 screwed thereon. Between that mounting zone 11 and the article 2 there is arranged both a conversion device 14 and a spring element 15 in the form of two stacked Belleville washers 16. The nut 13 is supported on that spring element 15 in the direction of the substrate 3. The spring element 15 is adjoined by the conversion device 14 in the form of two bearing shells 17, 18 stacked in the axial direction. The bearing shells 17, 18 have spherical sliding faces 19 which face one another and together form a sliding-contact bearing 28. The sliding faces 19 are concave seen in the direction of the substrate 3. In other words, the first bearing shell 17, which faces the spring element 15, has a convex shape, while the second bearing shell 18, which faces the substrate 3, has a concave shape. The second bearing shell 18 is fitted by its outer periphery 20 into a recess 21 in the article 2; the fit can be a loose fit or a press fit. It would also be possible for the second bearing shell 18, which together with the first bearing shell 17 forms a unit 22, to be joined to the article 2 by welding. A screw connection or adhesive connection would be equally possible. On the outer edge 23 of the spherical sliding face 19, the second bearing shell 18 has a plurality of transverse force elements 24 in the form of pins which project into the spherical face defined by the sliding faces 19. The transverse force elements 24 are joined integrally to the second bearing shell 18 via desired rupture locations 25. The first bearing shell 17 abuts those transverse force elements 24 so that the two bearing shells 17, 18 can be held rigidly relative to one another without the application of relatively large forces. Furthermore, a damping element 26 is arranged in the annular space between the shank 5 of the anchor 4 and the second bearing shell 18. It is supported radially inwards on the shank 5 and radially outwards on the second bearing shell 18.

The fixing arrangement 1 is assembled so that the spring element 15 is under tension, that is to say the nut 13 is tightened with a defined torque. The anchor 4 is accordingly pre-tensioned axially. Those forces are transferred from the nut 13 via the spring element 15 to the two bearing shells 17, 18 and further to the article 2, so that the latter is pressed against the substrate 3. That pressure has the effect that when transverse forces act on the article 2, that is to say forces acting transverse to the longitudinal axis of the anchor 4, they are compensated by frictional forces between the substrate 3 and the article 2. In that case, therefore, no transverse forces act on the anchor 4. If the transverse forces increase further, they can exceed the induced frictional forces. In that case, the forces are transmitted by the bearing shells 17, 18 via the transverse force element 24. From the first bearing shell 17 they are transmitted via the spring element 15 to the anchor 4. If the transverse forces increase further, for example as a result of an earthquake, at least one transverse force element 24 will break off at a desired rupture location 25 so that the bearing shells 17, 18 assume the function of the conversion device 14, resulting in the displaced arrangement of the fixing arrangement 1 shown in FIG. 2. The article 2, together with the second bearing shell 18, is displaced relative to the substrate 3 and the other parts of the anchor 4. By virtue of the spherical shape of the sliding faces 19, the first bearing shell 17 is rotated about the centre point of the sliding faces 19 relative to the second bearing shell 18. It thus moves overall slightly in the direction of the nut 13, so that the spring element 15 becomes more compressed. The pre-tensioning forces acting axially on the anchor 4 thus increase. Strictly speaking, as a result of the non-uniform deformation of the spring element 15 shown in FIG. 2, a very slight bending stress is also exerted on the shank 5. That stress is very low in comparison with the pre-tensioning forces acting axially, however, and, in particular, is significantly lower than in the case of the directly radially acting transverse force that an article exerts on the shank of an anchor, as known from the prior art.

In the state shown in FIG. 2, the spring element 15 acts simultaneously as a restoring element 27. The spring element 15, assuming ideal sliding characteristics of the bearing shells 17, 18 and between the article 2 and the substrate 3, would thus bring about a return movement into the state shown in FIG. 1 as soon as transverse forces no longer act on the article 2 from the outside. Accordingly, the spring element 15 acts as restoring element 27 as early as during the movement from the state shown in FIG. 1 into the state shown in FIG. 2, because it counteracts the displacement movement. Furthermore, the damping element 26, which is compressed in the course of the displacement, counteracts the displacement movement. As a result, in particular shock-related stress peaks can be reduced. It would be possible, in principle, to assist the described restoring movement by providing a low-friction layer or the like between the article 2 and the substrate 3. However, that would run contrary to the above-described transmission of transverse forces via the frictional action between the article 2 and the substrate 3. It is precisely that effect, however, that is important for relatively small loads, for which reason a low-friction layer between the article 2 and the substrate 3 would tend not to be preferred.

In addition to or as an alternative to the described procedures, when a transverse force acts on the article 2 the drilled hole 6 may become wider as a result of crack formation in the substrate 3. By virtue of the cones 8 and the pre-tension at the anchor 4, the anchor would be pulled a short way in the direction out of the drilled hole 6 and in so doing would expand further, that is to say would find a hold again within the hardened composition 9. It is precisely when crack formation in the substrate 3 is accompanied by high transverse force on the article 2 that the increase in pre-tensioning force as a result of the conversion device 14 is of particular importance in order to prevent direct radial transmission of transverse forces to the shank 5.

1. Anchor for fixing an article (2) to a substrate (3), characterized in that the anchor (4) has a conversion device (14) such that movement of an article (2) fixed with the anchor (4) relative to the substrate (3) and transverse to the longitudinal axis of the anchor (4) results predominantly in an increase in the axially acting pre-tensioning force of the anchor (4).

2. Anchor according to claim 1, characterized in that the anchor (4) has a transverse force element (24) which fails before the anchor (4) fails as a result of transverse forces.

3. Anchor according to claim 2, characterized in that the transverse force element (24) has a desired rupture location (25).

4. Anchor according to claim 1, characterized in that the anchor (4) has a restoring element (27) such that movement of an article (2) fixed with the anchor (4) relative to the substrate (3) and transverse to the longitudinal axis of the anchor (4) results in a restoring force on the article (2) opposing the movement.

5. Anchor according to claim 1, characterized in that the conversion device (14) has a sliding-contact bearing (28) between a mounting zone (11) of the anchor (4) and the article (2).

6. Anchor according to claim 5, characterized in that the sliding-contact bearing (28) has spherical sliding faces (19).

7. Anchor according to claim 5, characterized in that the sliding-contact bearing (28) has sliding faces (19) which are polished and/or coated, and/or a lubricant is arranged between the sliding faces (19).

8. Anchor according to claim 1, characterized in that the conversion device (14) has an axially acting spring element (15).

9. Anchor according to claim 5 and 8, characterized in that the spring element (15) is arranged between the mounting zone (11) of the anchor (4) and the sliding-contact bearing (28).

10. Anchor according to claim 1, characterized in that the anchor (4) has a damping element (26) for damping movement of an article (2) fixed with the anchor (4) relative to the substrate (3) and transverse to the longitudinal axis of the anchor (4).

11. Anchor according to claim 1, characterized in that the conversion device (14) takes the form of a unit (22) insertable into a recess (21) in the article (2) to be mounted.
